(19) United States
(12) Patent Application Publication
(10) Pub. No.: US 2008/0101366 A1
(43) Pub. Date: May 1, 2008

(54) METHODS FOR OPTIMIZED TUNNEL HEADERS IN A MOBILE NETWORK

(75) Inventors: NARAYANAN VENKITARAMAN, PALATINE, IL (US); VIDYA NARAYANAN, SAN DIEGO, CA (US)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/555,019

(22) Filed: Oct. 31, 2006

(51) Int. Cl. H04L 12/56

(52) U.S. Cl. 370/392

(57) ABSTRACT

A sending device replace an original Internet Protocol (IP) header in a packet with a shim that includes some information copied from the IP header, such that the resultant packet being sent from a source device to a destination device has a shim that is smaller in byte size than the header that it replaces. The receiving device copies some different information from the original header into another header. The sending device can further optimize the packet by: eliminating an IP header associated with a security protocol; eliminating a mobility tunnel for a node behind a mobile router (MR); and selective use of a security tunnel for the MR. A receiving device, upon receiving the optimized packet, restores the original IP header using the information in the shim (and other header(s)) and restores any other headers that were removed prior to forwarding the packet toward its intended destination.

### CROSS-REFERENCE TO RELATED APPLICATIONS

The present application is related to the following U.S. application commonly owned together with this application by Motorola, Inc. and incorporated by reference in its entirely:

Ser. No. 11/463,628, filed Aug. 10, 2006, titled “Optimized Tunneling Methods in a Mobile Network” by Narayanan, et al. (attorney docket no. CM07966BBH).

### FIELD OF THE INVENTION

The present invention relates generally to an Internet Protocol (IP) enabled communication network and more particularly to minimizing IP header overhead for packets sent within the network.

### BACKGROUND OF THE INVENTION

Packets sent in communication networks wherein nodes implement Mobile Internet Protocol (MIP) and/or some form of security protocol can be burdened with significant packet overhead due to one or more factors including, but not limited to, the size of the headers, multiple sets of IP headers and possibly also Transmission Control Protocol (TCP) or User Datagram Protocol (UDP) headers. For example, packets to and from nodes that are connected to a mobile network behind a mobile router may include four headers that are associated with four IP tunnels—two for the mobile router and two for the node connected behind the mobile router. This is especially a problem where such packets must traverse a narrowband wireless link.

Thus, there exists a need to optimize the use of IP headers in a communication network in order to minimize header overhead. Such optimization will enhance efficiency of the system overall, but will be especially useful for packets being sent over links that have a narrow bandwidth.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a communication network in which embodiments of the present invention are implemented.

FIG. 2 is a flow diagram illustrating a method for optimizing IP headers in the network illustrated in FIG. 1, in accordance with an embodiment of the present invention.

FIG. 3 is a flow diagram illustrating a method for optimizing IP headers in the network illustrated in FIG. 1, in accordance with an embodiment of the present invention.

FIG. 4 illustrates a prior art packet from a mobile node to a correspondent node.

FIG. 5 illustrates the packet of FIG. 4 after conventional Mobile Internet Protocol (MIP) and IP Security (IPSec) protocol processing.

FIG. 6 illustrates the packet of FIG. 4 after MIP and IPSec processing in accordance with an embodiment of the present invention.

FIG. 7 illustrates a Security Parameter Index format in accordance with an embodiment of the present invention.

FIG. 8 illustrates the packet of FIG. 4 after MIP and IPSec processing in accordance with another embodiment of the present invention.

FIG. 9 illustrates the packet of FIG. 4 after MIP and IPSec processing in accordance with another embodiment of the present invention.

FIG. 10 is a flow diagram illustrating a method for optimizing IP headers in the network illustrated in FIG. 1, in accordance with an embodiment of the present invention.

FIG. 11 is a flow diagram illustrating a method for optimizing IP headers in the network illustrated in FIG. 1, in accordance with an embodiment of the present invention.

FIG. 12 is a flow diagram illustrating a method for optimizing IP headers in the network illustrated in FIG. 1, in accordance with an embodiment of the present invention.

FIG. 13 illustrates a packet generated in accordance with an embodiment of the present invention.

FIG. 14 illustrates a packet generated in accordance with an embodiment of the present invention.

### DETAILED DESCRIPTION OF THE INVENTION

Before describing in detail embodiments that are in accordance with the present invention, it should be observed that the embodiments reside primarily in combinations of method steps and apparatus components related to a method and apparatus for IP header optimization. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

It will be appreciated that embodiments of the invention described herein may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus for IP header optimization described herein. As such, these functions may be interpreted as steps of a method to perform the IP header optimization described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment of the present invention can be implemented as a computer-readable storage element having computer readable code stored thereon for programming a computer (e.g., comprising a processing device) to perform a method as described and claimed herein. Examples of such computer-readable storage elements include, but are not limited to, a hard disk, a CD-ROM, an optical storage device and a magnetic storage device. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Generally speaking, pursuant to the various embodiments, a device that we'll call a sending device receives a message (e.g., a packet) comprising a first header having a first size (e.g., a given number of bytes) and comprising data (also referred to herein as payload). The sending device could be, for example, a mobile router, a correspondent node, a mobile node, a DCME (directly connected mobile entity), a node behind a mobile router or a MVPN server that serves any of the aforementioned nodes. The first header includes information to enable transport of the first message from a source device to a destination device. For example, the information may include Internet Protocol (IP) addresses for the source and destination devices, next header information and identification and fragmentation fields. The sending device generates a first shim that has a smaller byte size than the first header and that includes a first portion of the information from the first header (e.g., the IP address for the source device and/or the IP address for the destination device). The sending device generates at least a second header comprising a second portion of the information in the first header (e.g., the next header information and the identification and fragmentations fields). The sending device then generates a second message using the data, the shim and the at least a second header and forwards the second message toward the destination device.

A second device (which we'll call the receiving device) receives the second message and determines that it contains the first shim. Upon such a determination, the receiving device recreates the first header using the first and second portions of information, appends the recreated first header to the data to generate a third message and forwards the third message toward the destination device. Further optimizations could be realized where the sending and receiving devices implement both MIP and a security protocol. For example, where the security protocol creates both a security protocol header and an IP header associated with the security protocol header (e.g., an IPSec ESP header and associated IP header), the sending device could forward the second message without the associated IP header for the security protocol, such that the second message comprises the data, the shim, the IPSec ESP header and the IP header for MIP as the outer header. The receiving device in this embodiment would also have to recreate the security protocol IP header. Further optimizations can be realized in the case of packets being sent to and from a visiting mobile node (VMN) behind a mobile router. For example, in some implementations both the VMN and the mobile router use a security protocol. Thus in accordance with another embodiment, the mobile router (or MVPN server for the mobile router) forwards packets from (to) the VMN using only one security protocol tunnel.

Accordingly, embodiments of the present invention enable IP packets to be generated and transported in an IP-enabled system that are reduced in byte-size over packets that would normally be sent where optimizations in accordance with the teachings herein are not used. Those skilled in the art will realize that the above recognized advantages and other advantages described herein are merely exemplary and are not meant to be a complete rendering of all of the advantages of the various embodiments of the present invention.

Prior to describing the figures, a list of terms used herein is defined as follows.

IP is a protocol that enables nodes to communicate (transmit and/or receive) packets over the Internet and includes, but is not limited to, both IETF (Internet Engineering Task Force) Internet Protocol version 4 (IPv4) as defined in RFC (Request for Comments) 791 and all subsequent revisions and Internet Protocol version 6 (IPv6) as defined in RFC 2460 and all subsequent revisions, as are well known in the art.

A node (also referred to herein as an entity) is a device that implements IP.

A router is a node that forwards IP packets not explicitly addressed to itself.

A host is any node that is not a router.

A link is a communication facility or medium over which nodes can communicate at the link layer, such as an Ethernet, which is below IP.

An interface is a node's attachment to a link.

A unicast routable address is an identifier for a single interface such that a packet sent to it from another subnet is identified by that address.

A packet is a header plus payload (also referred to herein as data).

A tunnel is the path followed by a packet while it is encapsulated (using one or more associated headers). The model is that, while it is encapsulated, a packet is routed to a knowledgeable decapsulation agent, which decapsulates the packet and then correctly delivers it to its ultimate destination. A security tunnel is encapsulated using a security protocol header. A mobility tunnel is encapsulated using a mobility management protocol header (also referred to herein as a mobility header). An IP tunnel is encapsulated using an IP header.

A security protocol is used to create a security association between two nodes, which is a cooperative relationship formed by the sharing of cryptographic keying material and associated context. IETF IP Security protocol suite (also referred to as IPSec protocol) is an example of a security protocol.

A home address (HoA) is a unicast routable address assigned to a mobile node and used as the permanent address of the mobile node. This address is within the mobile node's home network.

A home network is a network, possibly virtual, having a network prefix matching that of a mobile node's home address. Standard IP routing mechanisms will deliver packets destined to a mobile node's home address to the mobile node's home network.

A mobile node (MN) is a node that can change its point of attachment from one link to another, while still being reachable via its home address. A mobile node can be a mobile router or a mobile host.

A correspondent node is a peer node with which a node is communicating and which may be either mobile or stationary.

A mobility management protocol is a protocol that enables nodes to change their point of attachment in a network while still being accessible by their home addresses. Well known standard Mobile IP (MIP) (as defined in RFC 3344 and all subsequent revisions entitled “IP Mobility Support for IPv4” and RFC 3775 and all subsequent revisions entitled “Mobility Support in IPv6”) is an example of a mobility management protocol.

A mobility agent is a router on a mobile node's home network (e.g., a home agent (HA)) or on a foreign network (e.g., a foreign agent (FA)) that implements a mobility management protocol to forward packets destined to the mobile node.

A foreign network is a network, possibly virtual, having a network prefix that does not match that of a mobile node's home address.

A visited network is a network other than a mobile node's home network, to which the mobile node is currently connected.

A binding is an association of the home address with a care-of address for a mobile node.

Registration is the process during which a mobile node sends a binding update to a mobility agent causing a binding for the mobile node to be registered.

A care-of address (CoA) is a unicast routable address associated with a mobile node while visiting a foreign network and is the termination point of a tunnel toward the mobile node for packets forwarded to the mobile node while it is away from its home network. For example, a foreign agent care-of address is an address of a foreign agent with which the mobile node is registered, and a co-located care of address is an externally obtained local address which the mobile node has associated with one of its own network interfaces.

A mobile network is a network having a network prefix assigned to a mobile router. A mobile network associated with a given mobile router and the nodes attached to the network are commonly referred to as being “located behind the mobile router”.

A directly connected mobile entity (DCME) is a mobile node (host or router) that is directly connected to access infrastructure, i.e., without going through a mobile router.

A shim is a piece of data that replaces a header and has a smaller bit or byte size than the header that it replaces. Where the header at least includes information enabling the transport of a message between a source device and a destination device, the shim includes only a portion of that information.

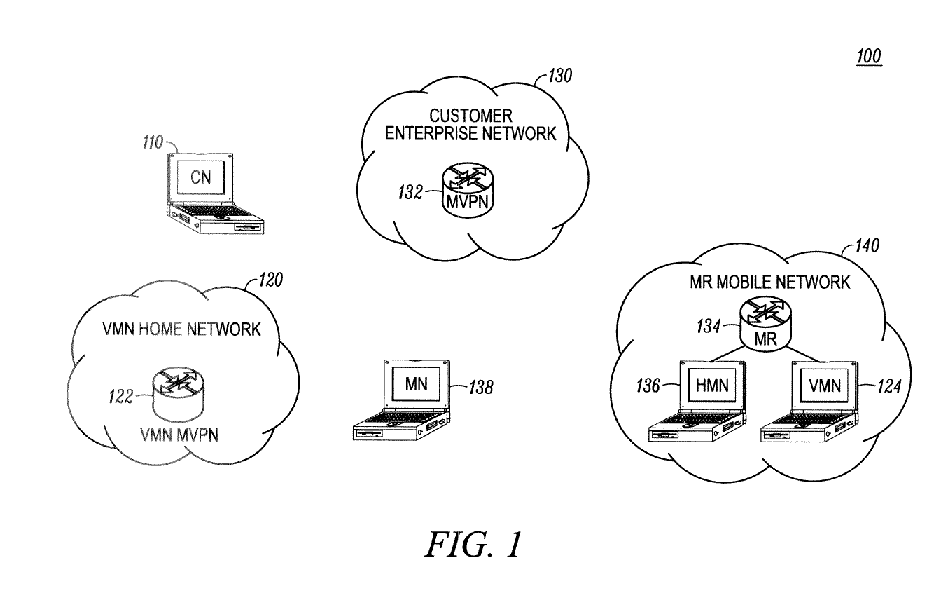

Referring now to the drawings, and in particular FIG. 1, a communication network in which embodiments of the invention are implemented is shown and indicated generally at 100. Those skilled in the art, however, will recognize and appreciate that the specifics of this illustrative example are not specifics of the invention itself and that the teachings set forth herein are applicable in a variety of alternative settings. For example, since the teachings described do not depend on the number of hosts, routers and servers in the network and the particular mobility management and/or security protocols implemented, they can be applied to a network implementing different mobility management and security protocols other than the particular ones described herein. Moreover, the teachings herein can be applied to a network of any size and including varying numbers of hosts, routers and servers although only a limited number of hosts, routers and servers are shown in the accompanying figures for the sake of clarity and ease of illustration.

Shown in communication network 100 is a home network 120 for a mobile host (VMN) 124 (and from which host 124 is assigned a HoA), a customer enterprise network (CEN) 130, which serves as a home network for a DCME (MN) 138 and a mobile router (MR) 134 (and from which MN 138 and MR 134 are assigned a HoA) and a mobile network 140 behind MR 134. Networks 120, 130 and 140 may be interconnected using any known wireless and/or wired means and may be further connected to other access networks and the Internet across which packets may flow from a source node to a destination node. Moreover, networks 120, 130 and 140 are IP-enabled networks, meaning that they each at a minimum provide IP connectivity for nodes and may further include devices that assign IP addresses for these nodes using IPv4 and/or IPv6. Networks 120 and 130 may further be reachable via Radio Access Networks (RANs) (not shown), for example, for facilitating media exchange between nodes connected to network 100. Also shown is a correspondent node 110 that communicates with nodes in network 100.

VMN home network 120 comprises at least one mobility agent such as a home agent (e.g., VMN MVPN 122) performing mobility management functions for mobile nodes (e.g., mobile node 124) using a mobility management protocol such as, for instance, MIP in this embodiment (although any suitable mobility management protocol can be used). As explained in more detail below, and as illustrated in FIG. 1, the home agent functionality may be co-located with security functionality, or the two functionalities may comprise separate physical devices. MN 138 is connected to an access network (not shown), for instance, through a FA (not shown) and obtains a CoA or CCoA in the access network. Customer enterprise network 130 comprises at least one mobility agent (e.g., MVPN 132) performing mobility management functions for mobile nodes (e.g., MN 138 and MR 134) using MIP. Connected to mobile network 140 is a visiting mobile node (VMN 124) and a home mobile node (HMN 136), wherein network 140 is the home network for HMN 136, and MR 134 serves as a mobility agent using MIP.

In an exemplary implementation, communication network 100 and the embodiments disclosed herein are practiced within a public safety context, although the teachings herein are in no way limited to such a context. However in such a context, an aim of communication network 100 is incorporating mobile networks (e.g., MR mobile network 140) into public safety vehicles, for example, to allow multiple devices (e.g., HMN 136 and VMN 124 that may be for instance Personal Digital Assistants (PDAs), portable radios, mobile radios, laptops, etc., but that are shown as laptops in this illustration) in the vehicle to access the CEN 130 and/or another network through a mobile router (e.g., MR 134), which is connected to these networks. In addition, communication network 100 ideally provides for secure delivery of packets over an access network or the Internet, for instance, as mobile nodes (e.g., MN 138) roam around network 100, and may further provide for authentication services to control who has access to and can use resources associated with the various networks.

Accordingly, in general, the architecture of communication network 100 is built upon MIP and virtual private network (VPN) security for both individual mobile hosts and for mobile networks. The VPN security is implemented using a security protocol, which for purposes of this discussion is IPsec protocol but can be any suitable security protocol depending on parameters including, but not limited to, customer requirements, system design constraints, cost constraints, etc. In this context, VPN implies a client/server remote access style of VPN, with at least the functions of encryption, user authentication, network authentication and basic key management.

As mentioned above, each logical home agent may be physically co-located with a logical VPN gateway (controlling the VPN functionality), such that a single server supplies mobility management and VPN gateway functions and to enable an IPSec tunnel to be based on a home address of a mobile node and be located inside of an MIP tunnel for enabling some of the header optimizations in accordance with the teachings herein. This single server comprising the co-located home agent and VPN gateway functionality is referred to herein as an MVPN server. Those of ordinary skill in the art will realize, however, that such physical co-location is not necessary in implementing the various teachings disclosed herein. In addition, IP and basic IP services (e.g., DHCP (Dynamic Host Configuration Protocol), DNS (Domain Name System), Web services, etc.) may be supported in communication network 100. It should be noted that only one MVPN server is shown in networks 120 and 130 (e.g., VMN MVPN 122 and MVPN 132, respectively) for clarity of illustration, but there may be additional such servers implemented in one or more of these networks as needed or desired by a customer. Moreover, in general, the architecture of communication network 100 further supports mobile routers that (besides the basic mobile router functions in accordance with MIP) may include functions such as a mobile host, a VPN client, a VPN gateway, a local WVAN (Wireless Vehicular Area Network) authentication server, a provider of basic IP services, etc.

The CEN 130 may deploy an AAA (Authentication, Authorization and Accounting) infrastructure with AAA servers, to authenticate various mobile nodes, and which implements an AAA protocol like RADIUS protocol, for example. Accordingly, the MVPN server further hosts an AAA client that communicates with an AAA server. The mobile routers and mobile hosts may be configured to dynamically obtain a CoA or co-located CoA (CCoA), and optionally support obtaining a FA CoA, and the mobile routers dynamically obtain at least one mobile subnet.

Additional detail regarding the architecture of the various elements comprising network 100 will now be provided to assist in understanding the operation of these elements and to later enable a deeper understanding of benefits associated with implementing the teachings herein. The CEN 130 hosts at least one MVPN server (e.g., 132). MVPN 132 is configured in accordance with the general architecture described above and, therefore, comprises multiple logical components including, but not limited to, a VPN gateway and a home agent. It may have additional functions of a DHCP server and an AAA client. However, in other embodiments some of these components may be implemented as standalone physical devices such as, for instance, the DHCP server. MVPN 132 may be connected to the CEN 130 using any suitable wireless or wired interface, but is usually connected using a wired interface such as, for instance, Ethernet. The VMN MVPN 122 can be configured similarly to MVPN 132 and have a suitable interface for connecting to network 120.

Mobile network 140 is a Vehicular Area Network (VAN) associated with a public safety vehicle, for example, and comprises MR 134 and may comprise Local Fixed Nodes (or LFNs, not shown), Home Mobile Nodes (or HMNs, with only one shown, e.g., HMN 136, for simplicity of illustration), Visiting Mobile Nodes (or VMNs, with only one shown, e.g., VMN 124, for simplicity of illustration), any additional nodes connected to MR 134 indirectly for instance using an adhoc network and mobile routers. LFNs, HMNs, VMNs and the MRs behind another MR are collectively referred to as MNNs (or mobile network nodes) and are supported by MR 134. In one embodiment, network 140 is further a wireless VAN (WVAN) providing Wireless Local Area Network (WLAN) connectivity around the vehicle for hosts (such as HMNs or VMNs or even LFNs) to connect wirelessly to the MR 134. However, MNNs may also connect to MR 134 through other means, such as Ethernet, USB, RB 132 and the like. Moreover, MR 134 can be directly attached to an access network (e.g., a RAN) through a transceiver or indirectly attached through a wireless modem in the vehicle, with the MR 134 to modem link being Ethernet, USB, RB 132, etc.

The basic functionality of MR 134 is to be a mobile router, and MR 134 can be a hardware or a software-based mobile router. As a mobile router, it provides IP connectivity to hosts (and routers) connected to mobile network 140. MR 134 is also responsible for advertising its capabilities inside the VAN. MR 134 can also act as a mobile host implementing MIP host functions and connecting to the CEN 130, for example, directly (as a DCME) and/or via another mobile router. MR 134 also provides other services in the VAN such as a VPN client, a VPN gateway, authentication, DHCP, DNS, etc. As a VPN client, it establishes security associations with its MVPN server (MVPN 132) and enables applications in the MR 134 to securely communicate with nodes within CEN 130. As a VPN gateway, it enables hosts connected to mobile network 140 to use the VPN connection between MR 134 and its MVPN server. Accordingly, MR 134 in this implementation comprises multiple logical components including, but not limited to, an AAA server or proxy, possibly an AAA client, an MIP client, a VPN client, a DHCP server and a DNS server.

As stated above, the MR 134 can support at least the following three types of MNNs. The Local Fixed Node is always fixed behind a particular MR and, typically, has no MVPN capability. In other words, these nodes generally do not have a Mobile IP or IPSec stack that needs to be supported. Accordingly, a LFN behind MR 134 comprises logical components of a DNS client and a DHCP client, respectively, to the DNS and DHCP servers in MR 134.

The Home Mobile Node is a mobile node behind the MR, which has its home on the mobile subnet behind the MR it is attached to. The HoA of a HMN belongs to the MR's mobile subnet, and it typically shares the same MVPN server (and hence the same home agent) as the MR to which it is attached. When a HMN roams to a different MR, it becomes a VMN.

A Visiting Mobile Node is a mobile node that does not have its home on the mobile subnet to which it is attached. In MIP terms, the VMN is in a “foreign network”, and obtains a CoA (or a CCOA) in the mobile network. Its HoA is usually part of the CEN 130 or another mobile subnet (in this case network 120). Note that a VMN may or may not share the same MVPN server (and hence HA) as the MR to which it is attached (and does not in this illustration). In this case, both the HMN 136 and VMN 124 are mobile hosts that have MIP host functions and VPN client functions that are substantially identical to MR 134. HMN 136 and VMN 124 comprise the same basic logical components of a DNS client, a DHCP client, an MIP client and a VPN client.

As stated above, also included in communication network 100 are correspondent nodes, with only one (e.g., CN 110) being shown for clarity of illustration and DCMEs (e.g., MN 138). DCME 138 in this implementation is a mobile host and is structurally and functionally similar to a mobile host such as HMN 136 and VMN 124 described above. However, a DCME could be a mobile router, and additional DCMEs could be included in network 100. Moreover, it should be realized that (although not shown) a DCME could be connected to the infrastructure via a foreign agent that may or may not implement some of the teachings herein. CN 110 has a home network, which may be network 120 or 130 or some other network, and CN 110 may be a fixed or mobile node. Let us assume, however, for purposes of this discussion and for clarity of illustration that CN 110 is in its home network, and the network connecting CN 110 and the mobility server with which it communicates is secure and no additional security or mobility headers are needed.

In accordance with embodiments of the teachings herein, optimizations will be explained for replacing IP headers with shims and also reducing IP headers (and thereby associated tunnels) when IP packets are being sent between any node behind a mobile router (e.g., MR 134) and a correspondent node (e.g., CN 110) or between a DCME (e.g., MN 138, MR 134) and the correspondent node. By adding intelligence into DCME 138, MR 134 and MVPN 132 and optionally in MVPN 122 and FAs in network 100, embodiments of the present invention enable replacing an IP header with a shim (also referred to herein as a HOS or header optimization shim); elimination of an IPSec IP header; elimination of an MIP tunnel for a VMN behind MR 134; and selective use of the VPN tunnel for MR 134. Thus optimizations of IP headers, in accordance with the teachings herein, can be realized with respect to IP headers (and associated tunnels), mobility management headers (and associated tunnels) and security headers (and associated tunnels).

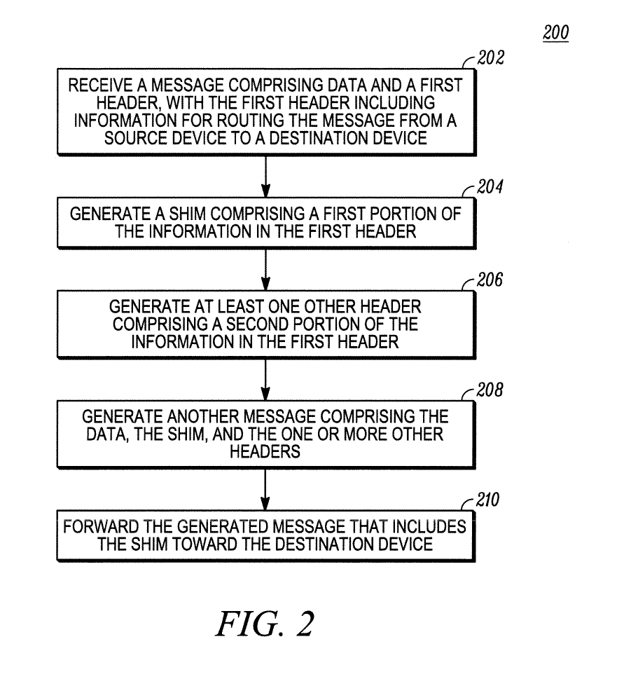

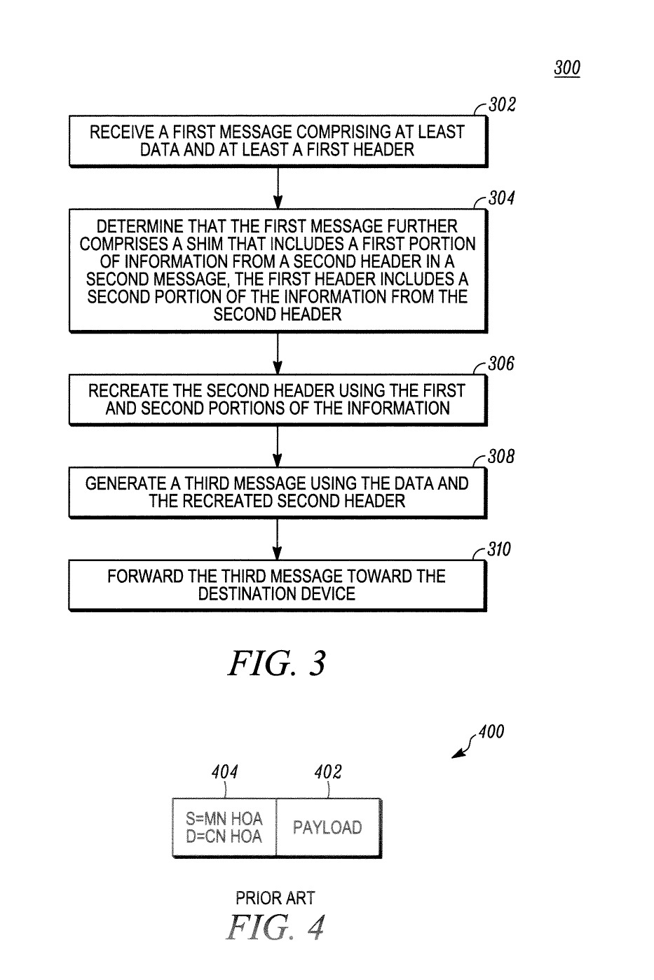

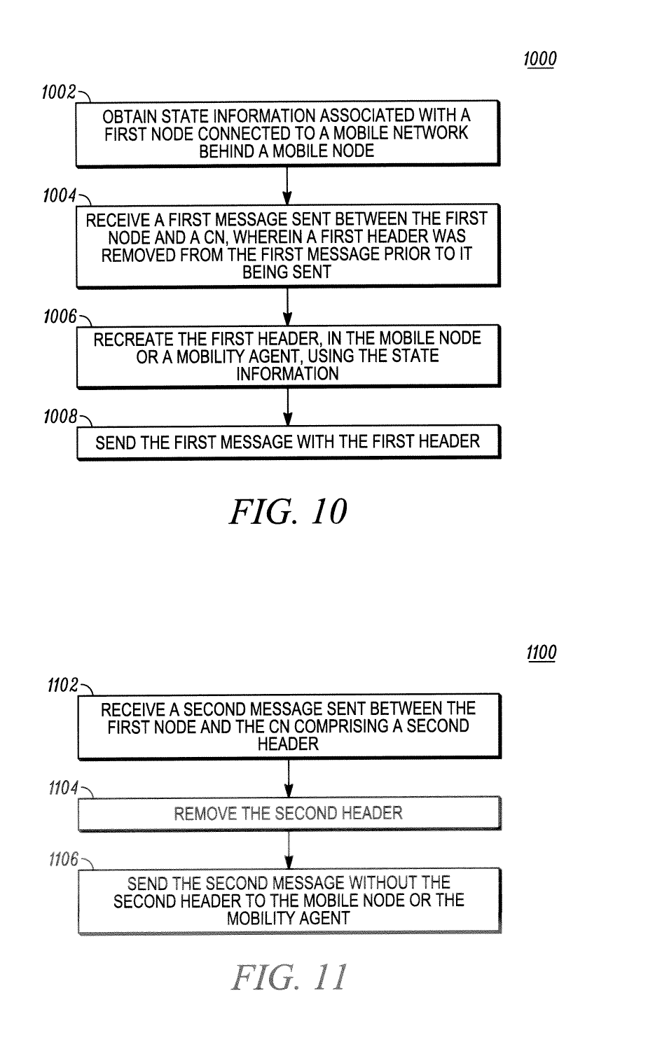

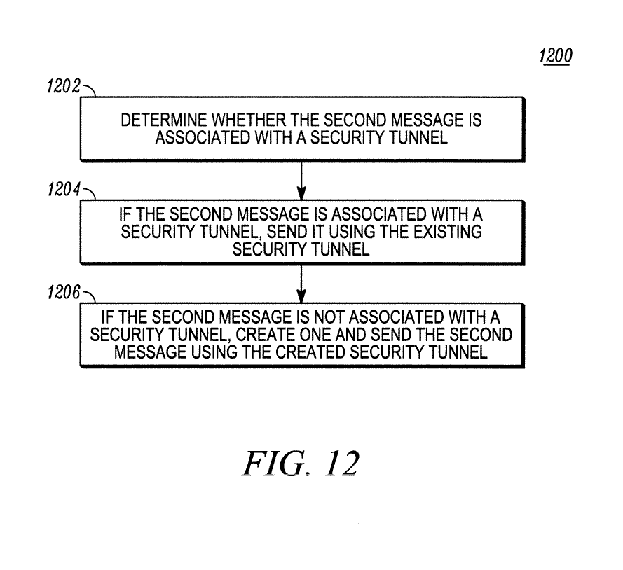

Some embodiments of the present invention are implemented as methods or processes, e.g., 200, 300, 1000, 100 and 1200 for optimizing headers in a network as illustrated, respectively, by the flow diagrams shown in FIG. 2, FIG. 3, FIG. 10, FIG. 11 and FIG. 12. These processes can be executed in hardware, software, firmware or any combination thereof in devices that include, for example, any mobile node (e.g., MR 134, a MNN such as VMN 124, a DCME such as MN 138, etc.) and any MVPN server such as MVPN 132 and MVPN 122. However, the teachings herein are not limited to execution in only these types of devices. For example where foreign agents are used, certain functionality in accordance with the teachings herein may be implemented in the FA. In that case, a mobility management tunnel between the DCME and its HA or between the MR and the MR's HA terminates at the FA. So, the FA could include the intelligence discussed in detail below instead of the DCME or the MR.

Moreover, processes in accordance with embodiments of the invention can be executed using apparatus that includes: any suitable memory, e.g., Random Access Memory, for storing state or other relevant information as discussed below; one or more processing devices, for example as described above, or processing modules or stacks that implement the optimization techniques discussed herein; and suitable interfaces (e.g., wireless, wired, software or a combination thereof) for sending packets to and receiving packets from the one or more processing devices, modules or stacks within a given device or a different device altogether. The functionality discussed below may also be implemented as a computer-readable storage element having computer readable code stored thereon for programming a computer (e.g., comprising one or more processing devices) to perform processes in accordance with the embodiments.

Since embodiments of the invention may be performed in a number of the devices illustrated in network 100, techniques for negotiating availability and use of header and tunnel optimization between these devices may be desired. In the case of integrated MIP and IPSec functionality, a MIP registration request and response can be used to negotiate availability and use of header and tunnel optimization. For instance, when a mobile node first registers with its MVPN server, it may use an extension in the registration request that we'll call a “Header Optimization Extension” that specifies the types of optimization supported by the mobile node. In the response, the MVPN server indicates an overlapping set of optimization features that it shares with the mobile node. In another implementation, Internet Key Exchange (IKE) can be used to negotiate optimization capability and use for the IPSec stack in the mobile node (independent of MIP). Moreover, in the case of a HMN and a VMN, the MR supporting those nodes could additionally determine the type of optimization supported by each node connected to its mobile network by snooping registration request and response messages sent between the nodes and their HAs.

We first turn to embodiments of the invention wherein a HOS is used for header optimization, as illustrated by exemplary methods 200 and 300. Method 200 describes the process for creating, in a sending device, a message (also referred to herein as a packet) using a HOS to replace a header, and forwarding or routing the packet with the HOS toward an intended destination device. Method 200, in general, includes the steps of: receiving (202) a first message comprising data and a first header having a first size, the first header including information to enable transporting or routing of the first message from a source device to a destination device; generating (204) a shim (HOS) having a second size that is smaller than the size of the first header, the shim comprising a first portion of the information in the first header; generating (206) at least a second header comprising a second portion of the information in the first header; generating (208) a second message comprising the data, the shim and the at least a second header; and forwarding or routing (210) the second message toward the destination device.

Method 300 describes the process performed in a receiving device, which receives the message from the sending device; recreates the header that was replaced by the shim and forwards a resulting packet with the recreated header toward the destination device. Method 300, in general, includes the steps of: receiving (302) a first message comprising at least data and at least a first header; determining (304) that the first message further comprises a shim having a first size and including a first portion of information from a second header having a second size that is larger than the size of the shim, the second header being included in a second message and the information from the second header to enable routing of the second message from a source device to a destination device, wherein the at least a first header includes a second portion of the information from the second header; recreating (306) the second header using the first and second portions of the information; generating (308) a third message using the data and the recreated second header; and routing (310) the third message toward the destination device.

We first consider optimizations wherein a packet is sent from a mobile node to a correspondent node (e.g., CN 110), wherein the mobile node can be a DCME or a MNN. The packets fall into one of two categories: (1) packets that are encrypted and/or authenticated, e.g., undergo IPSec ESP processing; and (2) packets that bypass the VPN and are, therefore, sent in the clear. FIG. 4 illustrates an original packet 400 created by a standard IP stack (implementing IPv4 and/or IPv6) in the mobile node, with the packet 400 comprising payload 402 and an IP header 404 that includes a source IP address of MN HoA and a destination IP address of CN 110 HoA. Although not shown, header 404 further includes information including, but not limited to, next header information, identification and fragmentation fields, Types of Service (ToS) field and Time to Live (TTL) field. The referenced information comprising header 404 are well known in the art and will not be discussed further here for the sake of brevity.

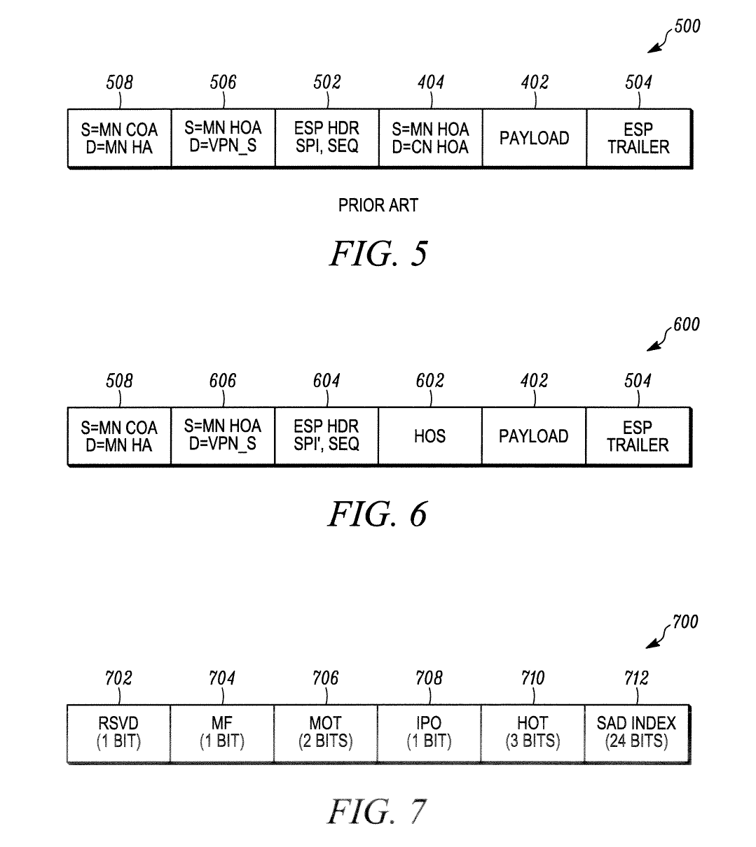

After standard IPSec and MIP processing (with no optimization) in the mobile node, the packet will look as shown in FIG. 5 and as labeled packet 500. Packet 500 comprises payload 402 and IP header 404 from packet 400. Packet 500 and further includes an IPSec (security protocol) Encapsulating Security Payload (ESP) Header 502, an IPSec ESP Trailer 504, an IPSec IP header 506 (associated with the security protocol header) added during the IPsec processing in the mobile node and an IP (mobility) header 508 added during the MIP processing in the mobile node. As illustrated, header 502 contains standard Security Parameter Index (SPI) and Seq fields in accordance with the IPSec protocol. As described in detail below, the four-byte SPI field (which is ordinarily used to index an entry in a Security Association Database (SAD)) can be used to implement header optimizations in accordance with the teachings herein. The use of part of the SPI to enable optimization is only an example. Other implementations may be done by using a new IP option, by adding a new IPv6 header extension, or by reusuing part of an existing field in an IP header or extension header. For instance, parts of the identification field or the fragmentation field may be used. Header 506 includes the mobile node HoA as the source address and the mobile node VPN server IP address (which in this case is the MVPN server IP address since the MIP and VPN functions are co-located) as the destination address. Header 508 includes the MN CoA as the source address and the MN HA (MVPN server in this case) IP address as the destination address in order to forward packet 500 toward CN 110 via the mobile node's HA.

The first optimization implementation discussed is for packets sent from a mobile node to CN 110, wherein the packets undergo both IPSec processing and MIP processing. Accordingly, the mobile node “receives” packet 400 (step 202) either via a software interface from another processing module within the mobile node (as in the case where a DCME or MNN is performing the optimizations itself) or receives the packet via a wireless (e.g., radio frequency, bluetooth) or wired (e.g., Ethernet, USB) interface from another node (as in the case of a MR performing optimizations for a MNN behind it). Upon receipt of packet 400, the mobile node generates (at step 204) a HOS to replace (original) inner header 404.

The HOS is smaller in size (e.g., 4 bytes) than header 404 (e.g., 20 bytes), and the HOS includes only a first portion of the information in header 404. In this exemplary implementation, the mobile node copies the entire destination IP address for CN 110 or at least the suffix portion of the IP address from header 404 to the HOS so that the HOS includes at least this portion of the information from header 404. The HOS may also include other information from header 404 or other information that is not in or related to header 404 such as, for instance information to enable the receiver to easily identify the HOS. For example, to enable the receiver to identify the HOS, the next header field in the header preceding the HOS may be set to IPinIP and the HOS may begin with an ALL zero byte field (instead of the normal 0100 or 0101 which would indicate IPv4 or IPv6). Other such values may be added to the HOS depending on the particular implementation.

Moreover, since the mobile node performs MIP and IPSec processing, it generates at least one other header (e.g., headers 502, 506 and 508) during its normal processing. In accordance with the teachings herein, the mobile node copies a different (second) portion of the information from header 404 into one or more of these headers (step 206). For example, the next header information in header 404 is copied to a next header field in the ESP Header, and the mobile node includes in another IP header (e.g., header 506) the same identification and fragmentation field offsets as in header 404. In one embodiment the more fragments (MF) bit in the original header is copied to a MF field in SPI and the MF bit in the newly created header is set to 0. Embodiments of the invention may further be combined with other techniques that enable UDP, TCP or other transport or session headers to be reduced or eliminated.

FIG. 6 illustrates a packet 600 generated (at step 208) and forwarded (at step 210) by the mobile node toward CN 110 that includes the payload 402 from the original packet 400 or a version thereof, a HOS 602 as described above that replaces header 404, an ESP Header 604 and IPSec IP header 606 generated during VPN processing that also contains information from header 404 as described above, a conventional ESP Trailer 504 generated in the VPN processing module and a conventional IP header 508 generated in the MIP processing module.

Prior to forwarding the packet, the IPSec module processes (e.g. encrypts) payload 402 and HOS 602. However, even though the shim 602 instead of the original inner header 404 is included for encryption, it is desirable to perform authentication of the ESP payload packet (including authentication of ESP Header 604, HOS 602 and payload 402) using at least some of the information in header 404 so that when header 404 is recreated in the receiving device, the reconstructed header 404 is substantially identical to original header 404. For example, the sending device can generate a message authentication code (MAC) for packet 600 (during authentication) based on the ESP payload packet prefixed with the original IP header present in the packet with any changing fields such as TTL, fragmentation offset, etc., set to zero and the CN IP address (which is already inside the HOS 602) also set to zero. After the receiving device has recreated the original header using the HOS (and the additional information from the other IP header(s)), it can re-compute the MAC based on the recreated IP header to ensure that the reconstructed header is substantially identical to the original header.

To distinguish between cases where the HOS optimization (and optionally additional optimizations) is used verses the case where the HOS optimization is not used, the sending device can use a suitable technique to indicate at least the presence of the shim (and other optimizations) in the packet. For example, as is illustrated by the SPI′ in ESP header 604 (FIG. 6), the sending mobile node can use a part of the SPI field in the ESP header to provide such an indication. In another embodiment the next header field in an outer IP header (e.g., header 508 or 606) can be set to a non-ESP value to provide the indication. Moreover, other options, such as IP options, can also be used. Regarding use of the SPI field, SPI typically points to the SAD entry corresponding to the security association (SA) between the MVPN server and a mobile node—in this case the mobile node source device in header 404. The SPI is 32 bits long to allow 2³² unique entries. However, the mobile node is unlikely to have 2³² unique SAs at any given time. Therefore, a portion of these bits can, alternatively, be allocated for indicating the use of optimization techniques (including the use of a HOS in a packet). For example, twenty-four bits can be allocated for the actual SPI value and the remaining eight bits allocated for optimization indication.

FIG. 7 illustrates one exemplary SPI format 700 for indicating various optimization techniques in accordance with the teachings herein. For SPI format 700, one bit 702 is reserved for future use and can, therefore, be set to zero. One bit is allocated to a MF (More Fragments) value 704 that is copied from the MF field in header 404. The receiving device copies value 704 back into the reconstructed header 404. Two bits are allocated to a MOT (Mobile Router Optimization Type) value 706, which indicates optimizations applied to packets sent to and from a VMN behind a mobile router. One bit is allocated to an IPO (IP options) value 708, which indicates the presence of any IP options following the HOS, as is the case, for example, where the original header 404 was followed by IP options. Three bits are allocated to a HOT (Header Optimization Type) value 710, which indicates the type of HOS that follows the ESP Header, and twenty-four bits are allocated to a SAD index value 712.

As mentioned above, in one implementation a MR can perform optimizations on packets sent to and from a VMN behind the mobile router. The MOT bits are used to indicate this implementation. Therefore, the MOT bits can be set to 00 for packets sent to and from a DCME or a LFN or HMN behind a mobile router. Only the mobile router and its MVPN Server process the MOT bits and these entities clear (set to zero) the MOT bits prior to passing a packet to the VMN or its MVPN Server. Exemplary values for the MOT bits are: 00—indicating packets that are associated with a node other than a VMN; 01—indicating packets optimized by both a MR and a VMN behind the mobile router and the presence of two shims, with an HOS added by the MR and containing the VMN IP address and another HOS added by the VMN and containing the CN IP address; 10—indicating unoptimized VPN-bypassed packets (discussed in more detail below) from the VMN that are optimized by the MR, and the 10 value further implying that a packet has been encrypted by the MR (or its MVPN server) and that the packet should be decrypted and the original inner header and VMN MIP tunnel restored before the packet is passed to the VMN or its MVPN server; and 11—can be used to indicate if the protocol headers that follow IP (such as UDP/RTP or TCP headers) have been compressed.

Further as mentioned above, the IPO bit shows the presence or absence of IP options in the original (innermost) IP header (e.g., 404) of the packet. For example, zero (0) indicates the absence of IP options and one (1) indicates the presence of IP options in the inner header. Moreover, this bit helps the receiving device to correctly determine the length of the IP header, wherein the length of the IP options is added to the 20 byte IP header length.

The HOT bits can be used for entities including: a DCME that performs its own optimization; a MR performing optimization on packets from LFNs, HMNs, or VMNs that completely bypass their MVPN tunnel; and VMNs that perform their own optimization. Exemplary values for the HOT bits are: 000—indicating that the packet is unoptimized; 001—indicating that the HOS contains only the CN IP address; 010—indicating that the HOS contains both CN and MNN IP addresses; 011—indicating that the HOS contains only the MNN (e.g., VMN HoA) IP address.

This modified SPI (SPI) is now present in the ESP header to at least indicate the presence of the HOS after the ESP header and may also indicate further optimizations as referred to above. After IPSec processing, a packet comprising payload 402, HOS 602, ESP Header 604, ESP Trailer 504 and IPSec IP header 606 is passed on to the MIP module of the mobile node. If IP options are present in the original packet then the IP Options follow the HOS. The outer header 606 length includes only the length of the header (20 bytes), and the length of the IP options can be included as a last field in the HOS if the IPO bit is set. Typically, the MIP module simply adds the MIP tunnel (by adding header 508) to the incoming packet. However, in another embodiment the packet can be further optimized by the mobile node adding the MIP header in place of the IPSec IP header. In this case, all relevant fields from header 404 as discussed above are, alternatively, copied to the MIP IP header instead of header 606.

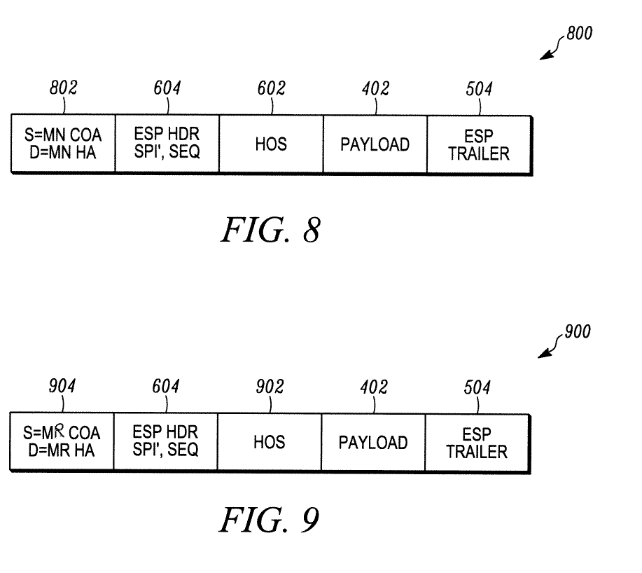

The resulting packet after this processing implementation is illustrated as a packet 800 in FIG. 8. Packet 800 comprises the payload 402, HOS 602, ESP Header 604, and ESP Trailer 504 as in packet 600. However, the only other IP header in packet 800 is a header 802 completed by the MIP module. For instance, the IPSec module could create header 606 and the MIP module just modify this header by replacing the IP source and destination addresses with the CoA of the DCME and HA IP address, respectively. The HA IP address is the same as the MVPN Server IP address in the case where the VPN server and HA are co-located. The MIP module could, alternatively, create a separate IP header 802 with the CoA of the DCME and HA IP address and copy the header 404 information from IPSec IP header 606 and discard header 606. Moreover, the IPSec module could pass a packet to the MIP module without the IPSec IP header, and the MIP module could create the outer header from scratch that includes the requisite header 404 information.

As mentioned above, in one implementation packets are sent to and from a MNN behind a mobile router. For this implementation further indications in the packet are useful to properly reconstruct the inner IP header 404 at the receiving device. For instance, the sending device performing the optimizations adds a further indication to the packet to enable the MR or the MVPN server (depending on which direction the packet is traveling) to distinguish between whether a packet is to or from the MR or the MNN behind the MR. An indication that a packet is to or from the MNN may include, but is not limited to, also including the MNN IP address in the HOS and setting the HOT bit value to 010 to indicate that the HOS contains both CN and MNN IP addresses.

FIG. 9 illustrates a packet 900 originating from a MNN, wherein the MR optimizes the packet in accordance with the teachings herein (with the MIP IP header having the information from header 404) and also provides encryption for the MNN. Packet 900 comprises the payload 402, ESP Header 604, and ESP Trailer 504 as in packet 600, a HOS 902 including both the CN and MNN IP addresses and an MIP IP Header 904 including the MR CoA as the source address and the MR HA (in this case MR MVPN server) IP address as the destination address. Packet 900 applies to all packets originating from LFNs, HMNs and VMNs that bypass their own VPN tunnel (or that don't use a security protocol). In the case of a VMN using its own VPN tunnel, if the destination of the packet is the VMNs MVPN server, then that destination need not be indicated in the packet (i.e., the MIP header for the VMN can be eliminated from the packet as is the case with packet 900 and as is described in more detail below) because the MR and its MVPN server can obtain that mapping using a MIP registration reply from the VMNs MVPN server for instance. In such a case, a HOT bit value of 011 is used to indicate that only the VMN source address is included in a HOS.

We now turn back to method 300 of FIG. 3. Accordingly, a receiving device, e.g., MVPN server 122 or 132, receives (at step 302) an optimized packet and performs header reconstruction on the packet based on the particular optimizations detected in the received packet before forwarding the packet to the correspondent node, e.g., CN 110 (at step 3 10). The process involves re-constructing the original packet (e.g., 400) to deliver to CN 110 and, essentially, follows the reverse of the steps described above. Accordingly, the packet gets delivered to the MIP module first. If the packet was sent without an IPSec IP header (e.g., packet 800 or 900), the MVPN server detects that this header was removed, restores the header and copies the header 404 information from the MIP IP header to the recreated IPSec IP header. Similarly, the MVPN server may detect that a VMN MIP IP header was removed and also restore this header.

For example, the MVPN server can detect the removal of the IPSec IP header (and hence optimization of the MIP header) using the following implicit approach. In the packet if the next header field in the MIP IP header indicates IPIP, then the packet is not optimized and normal MIP processing is performed on the packet. However, if the next header field indicates the ESP header, then the MVPN server can implicitly assume that the MIP header has been optimized since the MVPN server usually expects packets in tunnel mode (i.e., a next header of the IPSec IP header) when the ESP header is present. Hence, the absence of another IP header (i.e., an IPSec IP header) inside the MIP tunnel indicates that the MIP IP header has been optimized. In another implementation, the reserved bits in the SPI can be used to detect the removal of IPSec IP header. The MIP module, in this case, replaces the source address with the HoA of the MR or DCME. The HoA is determined by mapping the CoA in the packet header (in conjunction with UDP source port if UDP tunneling is used) to the HoA in the registration table.

After performing its processing, the MIP module passes the packet to the IPSec module, which detects (at step 304) that the packet includes at least one shim. The IPSec module reconstructs or recreates (at step 306) header 404, based on the value of the SPI field in the ESP header, the HOS contents and relevant contents in the IPSec IP header before routing a resulting packet (generated at step 308) toward the CN 110 (at step 310). The ultimate goal is creating in a receiving device a packet that is substantially identical to the original packet 400 sent by the mobile node to the correspondent node and having a header that is substantially identical to header 404, wherein the source IP address in the recreated IP header is usually the HoA of the mobile node and the destination address is the CN IP address. The MVPN server can obtain the source IP address for the mobile node using the mapping of the mobile node HoA and CoA that it maintains and can obtain the CN IP address from the information included in the HOS.

More specifically, the IPSec module receives the packet from the MIP stack. Only the 24 bits of SPI are used to look-up the SAD entry. Once the packet has been decrypted, the IPSec module performs the following processing on the received packet. If the HOT bits are set to 000, then normal IPSec processing is performed, wherein the inner header (e.g., 404) is matched with SAD values, and, if okay, the inner packet (e.g., header 404 and payload 402) is sent to upper layers in the MVPN server. In cases where the HOT bits are set to other than 000, sequence number matching and anti-replay protection are performed as normal, and an integrity check may be performed before decryption or in parallel with decryption. For either case of the integrity check, the receiving device prefixes the ESP payload with a pseudo IP header comprising the received outer IP header (e.g., the IPSec IP header) with the CN field and other changing fields such as TTL, fragmentation offset etc., set to zero (0). The CN field is set to zero because the CN IP address is included inside the ESP encrypted payload and is, hence, authenticated. Thus, the receiving device obtains the CN address after decryption.

If the HOT bits are set to 001, then the header 404 is recreated by setting the destination address to be the address in the first four bytes of the HOS (following the ESP header) and by setting the source address to the source address of the packet received from the MIP stack (the packet from MIP stack has the HoA of the MN as the source address—see header 606 of FIG. 6). Alternately, the value in the SAD corresponding to the SPI can be used to obtain the source address, since a 001 value for HOT indicates that the packet is from a DCME, and the IPSec SA is tied to the HoA of the DCME. If the HOT bits are set to 010 (which indicates the packet is from a MNN), the header 404 is recreated by setting the destination address to be the address in the first predetermined number of bytes of the HOS (following the ESP header) i.e., the CN IP address, and setting the source address to be the address in the next predetermined number of bytes of the HOS, i.e., the MNN IP address.

In both of the above cases, the header 404 information contained in the IPSec header, e.g., identification field, ToS, etc., are all copied into the recreated IP header 404. The MF field is copied from the MF field in SPI. The next header field is copied to the recreated header 404 from the ESP next header field. ToS is either copied as is, or reverse mapping is performed in cases where such mapping exists at the MVPN server. If the IPO bit is set to 1, then in addition to the above steps, the IP header length is incremented by the value in the first byte following the source and destination addresses in the HOS. This is done to include the length of the IP options that are present in the original packet. Once the inner IP header 404 is fully reconstructed, it is prefixed to the payload 402 and the packet is routed toward CN 110.

The above description focused on the case wherein packets are sent from a mobile node to a correspondent node. However, the processing is substantially the same in the reverse direction from the correspondent node to the mobile node, with optimizations being performed, for example, at a MVPN server for a MNN or for a DCME. The packets are similar to those illustrated in figures four through six and eight through nine except that the source and destination addresses in the headers are reversed. Moreover, the same SPI format 700 as illustrated in FIG. 7 can be used when the packets are sent in the reverse direction from the correspondent node to the mobile node.

Moreover, the above description focused on the case where VPN processing is implemented. Described next is an embodiment wherein header optimization is performed when VPN processing is not implemented (such as when such processing is bypassed or simply not used), and there is, therefore, no ESP header included in the packet. Let us call this embodiment the “bypass mode of operation”. Such an embodiment can be used, for example, when a DCME has a co-located CoA from its access network, or the FA in the access network supports the optimization.

The bypass mode of operation will be described by reference to a packet being sent from a mobile node to a correspondent node. However, the discussion is equally applicable to the other direction with the exception being that the source and destination addresses in the headers are reversed. Accordingly, packet 400 is delivered from the IP stack to the MIP processing module in the MN. The MIP processing module typically adds an outer tunnel header without modifying anything in the inner packet. The resulting packet is one comprising only the payload 402, the header 404 and the header 508 from packet 500. In accordance with the teachings herein, the MN can replace the header 404 with a HOS. The HOS in this case includes at least the information from the header 404 that was included in the HOS implementation described above (with respect to the VPN processing embodiment) and may also contain more of the information from header 404 to aid in reconstructing header 404 and/or indicating the presence and/or type of optimizations in the packet. The MIP IP header includes all other fields and portions of the information from header 404 that will be needed by the receiving device to reconstruct header 404. As should be understood based on the above teachings, in another embodiment an MVPN server or MR could perform the optimizations in the bypass mode of operation.

However, the inclusion of the HOS in the packet is indicated differently. For example, IP options can be used to indicate that a HOS follows the MIP IP header, or the next protocol field in MIP IP header can be used for such an indication. In the latter case, the HOS further includes bits for a “next protocol” to identify what follows the inner IP header 404. In addition, the next header in outer IP header (e.g., MIP IP header or a UDP tunnel header) can be used indicate the type of packet that follows the HOS. The presence of optimizations are implicitly known based on the lack of IPIP. This indication works in all cases except for when the mobile node is sending an IPIP packet to the correspondent node itself. In that case, the next header that follows the HOS will be IP. Accordingly, the presence of HOS is detected as follows. The HOS has the first byte set to all zeros (IP will normally expect the first byte to contain the version, which is a non-zero field). The second and third bytes are reserved and are set to 0. The final byte has the same format as the byte used in SPI to indicate optimization. This approach indicates HOS using zero instead of IP protocol and compensates for lack of IPSec SPI in an ESP header by adding a field as part of the HOS. Following this, the CN IP address can be included in the HOS.

Following are additional optimization techniques in accordance with embodiments of the present invention. In one embodiment, when the MVPN server detects a level of traffic (e.g., data exchanged) between a given MN-CN (source and destination device) pair that exceeds a threshold, the MVPN server may optionally generate and send in packets to a DCME (MN or MR) an index that is representative of the MN-CN pair. This index may be used in place of the HOS or in place of one or more IP addresses carried in the HOS and can be, in one exemplary implementation, embedded as a value in the SPI field of an ESP header. This embodiment can save an extra four to eight bytes on the packet, which is valuable when a large amount of data is exchanged with the same correspondent node. The DCME can also perform this optimization in the reverse direction.

Further optimization may be realized for packets sent between a VMN and the correspondent node, as mentioned briefly above. These optimizations are next described in additional detail. In many instances VMNs may have an MVPN server that is different from the MVPN server of the mobile router to which it is attached. Hence, they maintain an MVPN tunnel with their MVPN server even after moving into the mobile network subnet of a MR. In a typical case, a VMN would add its own MIP and IPSec tunnels and pass the packet on to the MR, which then adds its MIP and IPSec tunnels. This results in an overhead of over 80 bytes. However, the embodiments described below reduce such large tunneling overhead for packets sent to and from the VMN.

In order to provide tunnel optimizations for the mobile node, the MR and the MR's MVPN Server needs to obtain and track state information. More particularly, in order to provide tunnel optimizations for VMN 124 (for example), MR 134, MVPN 132 and VMN MVPN 122 obtain certain information from the mobility, and optionally VPN associated headers of the packets to and from VMN 124 and stores this information (in any suitable internal memory element). This information is referred to herein as “state” information and comprises one or more of the following: the VMN 124 HoA and CoA, an IP address for the VMN HA; a Security Parameter Index (SPI) associated with a VPN connection; and an IP address for the VMN VPN server. In one embodiment, this state information is obtained from a registration request message from VMN 124 to VMN MVPN 122 upon connecting to network 140 and/or a registration reply message from VMN MVPN 122 to VMN 124 responsive to the registration request, since MR 134 and MVPN 132 are in the path of the registration message exchanges between VMN 124 and VMN MVPN 122 and since the registration request and reply contain the VMN 124 HoA and CoA and HA IP address. For certain security tunnel optimizations, MR 134 and/or MVPN 132 may obtain further state information such as the VPN server IP address (for VMN MVPN 122) from messages between VMN 124 and VMN MVPN 122 such as, for instance, Internet Key Exchange (IKE) messages that contain this state information.

In this embodiment, both the MR 134 and MVPN 132 can independently obtain the state information from the registration (or security association) message sequence, or one of the devices can extract the information and forward it to the other device. In this case, ideally MR 134 extracts the state information since it usually deals with much less traffic than the MVPN 132. Moreover, in a beneficial embodiment, the state information is extracted only upon detection (using any suitable means) of a successful registration reply (or security association). This preserves storage space in MR 134 and MVPN 132.

In alternative embodiments, the state information may be obtained in other ways. For example, the MR 134 may obtain the state information using a separate message exchange with VMN 124 (separate from the registration message exchange or security association message exchange, that is), wherein VMN 124 notifies MR 134 of the state information. In another embodiment, a new DHCP option may be used to notify MR 134 of the state information. MR 134 could also detect state information for VMN 124 “on the fly”, upon receiving an encapsulated packet from VMN 124. In this case, the state information is beneficially stored only upon receipt of a first reverse tunneled packet from VMN 124. Upon extracting and storing the state information for VMN 124, MR 134 communicates this information to MVPN 132 so that MVPN 132 can also save the state information.

Turning now to FIGS. 10 and 11, methods for minimizing tunnels in a network in accordance with embodiments herein are shown and generally indicated at 1000 and 1100. These methods can be implemented concurrently with methods 200 and 300 described above (in which a HOS is used) to provide for additional reduction in header overhead for packets sent to and from VMNs behind a mobile router. Method 1000, in general, includes the steps of obtaining (1002) state information associated with a first node (e.g., VMN 124, HMN 136 or a LFN) connected to a mobile network (e.g., network 140) behind a mobile node (e.g., MR 134), for example, as explained above; receiving (1004) a first message sent between the first node and a correspondent node (e.g., CN 110), wherein a first header (MIP and/or VPN associated) was removed from the first message prior to the first message being sent; recreating (1006), in the mobile node or a mobility agent (e.g., VMN MVPN 122, MVPN 132), the first header using the state information; and sending (1008) the first message with the first header. Method 1100, in general, includes the steps of receiving (1002) a second message sent between the first node and the correspondent node, the second message comprising a second header; removing (1004) the second header; and sending (1006) the second message without the second header to the mobile node or the mobility agent. Both methods will be explained in further detail.

Explained first is how MR 134 and MVPN 132 use this stored state information for VMN 124 to implement embodiments of the present invention when packets are routed between CN 110 and VMN 124. It is assumed for purposes of this first example that no security protocol is used by MR 134 or VMN 124. However, in many implementations a security protocol is used, and additional optimizations are later described for such security protocol implementations. Optimizations can be performed on the link between MVPN 132 and MR 134 to eliminate a mobility header from the packet. In this case, the HA in MVPN 132 performs method 1100 (of FIG. 11) on a packet that includes payload, an original IP header having the CN 110 IP address as the source address and the VMN HoA as the destination address, and a mobility header for VMN 124 having the VMN HA (MVPN server) IP address as the source address and the VMN CoA as the destination address, wherein: MVPN 132 (at step 1102) receives the packet; removes (at step 1104) the VMN mobility header and inserts its own mobility header, which includes the IP address for the HA of MVPN 132 as the source address and a CoA for MR 134 as the destination address; and sends (at step 1106) the packet to MR 134 without the VMN mobility header. In this message sequence, MR 134 performs steps 1004, 1006 and 1008 (of FIG. 10): wherein it receives (at step 1004) the packet; recreates (at step 1006) the VMN mobility header using the state information that it has stored for the VMN 124; and sends (at step 1008) the resulting packet to VMN 124.

When the HA (of MVPN server 132) “removes” (at step 1104) the VMN mobility header and “inserts” its own header, this could have more than one implementation. In one embodiment, the HA may update the necessary fields in the existing VMN mobility header to create the modified mobility header. For instance, IP version number, Type of Service (TOS) and identification fields may stay the same, but the source and destination IP addresses are modified. In another embodiment, the HA may create a fresh IP header, wherein it fills in the necessary fields.

As indicated above, further optimizations can be realized where a security protocol is used. FIG. 12 illustrates a method 1200 that embodies an exemplary such optimization that can be performed in the MR 134 or the MVPN 132. In general, either the MR 134 or the MVPN 132 (depending on the direction of the message sequence flow) further: determines (1202) whether the packet is associated with a security tunnel; if the packet is associated with a security tunnel, sends (1204) the second message using the security tunnel; and if the packet is not associated with a security tunnel, creates (1206) a security tunnel and sends the packet using the created security tunnel, thereby, using only one security tunnel.

Depending on the particular implementation, VMN MVPN 122 may send packets with or without a VPN tunnel, or in other words the packets may be encrypted or unencrypted. Where VMN MVPN 122 sends unencrypted packets without a VPN tunnel, the MVPN 132 creates a VPN tunnel and in accordance with the teachings above further removes the VMN 124 MIP tunnel and inserts the MR 134 MIP tunnel. This embodiment may be used, for example when the MR 134 and the VMN 124 belong to the same administrative domain, implying that the VPN tunnel is not required between the MR MVPN server and the VMN MVPN server.

However, in the event where the VMN 124 and MR 134 belong to different administrative domains, VMN MVPN 122 may use a VPN tunnel for sending packets comprising encrypted data between itself and MVPN 132. In that case, the MVPN 132 can forward the packets using the VPN tunnel already associated with the packet (which was established by VMN MVPN 122), and in accordance with the previously discussed embodiment further remove the VMN 124 MIP tunnel and insert the MR 134 MIP tunnel. In one implementation, The MVPN 132 may detect encryption based on the presence of an IPSec ESP header.

Moreover, an additional optimization can be implemented where a security protocol is used along the path from CN 110 to VMN 124. In general, when VMN MVPN 122 establishes a security tunnel (in this case using IPsec protocol) an IP header associated with the ESP Header that would normally be included in the packet from MVPN 122 to VMN 124 can be eliminated and then recreated in MR 134. This embodiment is discussed above with respect to the HOS embodiment. Accordingly, the outer MR mobility header is followed by the ESP header instead of an IPSec IP header. Numerous variations of this implementation within the scope of the teachings herein can be envisioned by one of ordinary skill in the art. A few such variations are as follows. For example, on the path from CN 110 to VMN 124 the VMN MVPN 122 or the MVPN 132 could establish the security tunnel and perform the optimization omitting the IPsec IP header. Also, where CN 110 sends packets to HMN 136 or a LFN behind MR 134, only the MIP tunnel for MR 134 is used, and a security header could further be deleted where MVPN 132 established a security tunnel.

The above description focused on the case wherein packets are sent from a correspondent node to the VMN. However, the processing is substantially the same in the reverse direction from the VMN to the correspondent node, with optimizations being performed, for example, at the VMN and/or the MR. The packets are similar except that the source and destination addresses in the headers are reversed.

As can be seen by the above detailed description, there are numerous optimizations combinations when packets are sent to and from a CN and VMN. In the simplest case, the VMN may be sending the packets natively in bypass mode (i.e., bypassing its MVPN tunnel) to the MR. In a second case, the VMN may be already performing the HOS optimizations discussed in detail above. In a third case, the VMN may be sending an unoptimized MVPN tunneled packet to the MR. A fourth case may be where the VMN bypasses its VPN tunnel, but not its MIP tunnel.

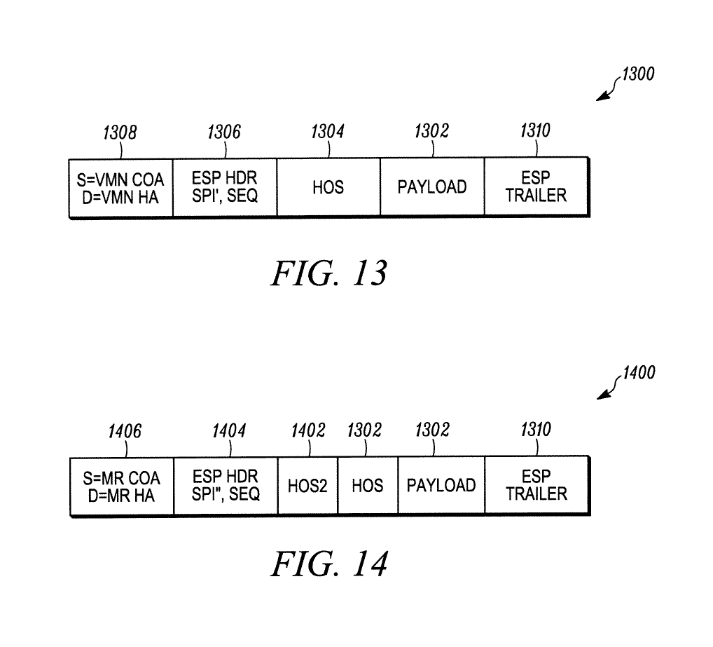

FIGS. 13 and 14 illustrate an implementation where both the MR and the VMN behind the MR perform optimizations on a packet from the VMN to a CN. In accordance with this embodiment, the VMN (e.g., VMN 124) performs the HOS optimization, uses its own security tunnel and forwards a packet to MR 134 that looks like packet 1300 illustrated in FIG. 13. Packet 1300 comprises: a payload 1302; a HOS 1304 in accordance with the teachings above and including at least the IP address for CN 110 from an original header (not shown); an ESP Header 1306 and mobility header 1308 in accordance with the teachings above that include information from the original header, with the VMN CoA as the source address and the VMN HA (MVPN Server) IP address as the destination address; and a conventional ESP trailer 1310. Thus, VMN 124 replaces the original header with a shim and eliminates the IPSec IP header.

The MR 134 receives packet 1300 and generates a further optimized packet such as a packet 1400 illustrated in FIG. 14. In this implementation, the MR adds a second HOS, uses the VPN tunnel established by the VMN 124 and replaces mobility header 1308 for VMN 124 with a mobility header 1406 for MR 134 (and correspondingly transfers the original header information from header 1308 to the MR mobility header). Accordingly, packet 1400 comprises payload 1302, HOS 1304 and ESP Trailer 1310 as in packet 1300. However, packet 1400 further comprises: a second HOS (HOS2) 1402 that includes at least the VMN CoA; a modified ESP header 1404 having denoted therein a field SPI″, which is field SPI′ from header 1306 being modified to further indicate the additional optimizations performed by the MR; and a mobility header 1406 that includes the MR CoA as the source address and the MR HA (MVPN Server) IP address as the destination. The relative location of the HOSs with respect to each other and with respect to the ESP header is only exemplary. In another embodiment, for instance, one HOS can be located before the ESP header and one after.

As stated above, ESP Header 1404, in addition to indicating the optimizations performed by VMN 124, further indicates optimizations performed at the MR 134. More specifically, the MR uses the two bit MOT value in the SPI″ of ESP header 1404 to indicate its optimizations. Note that use of the MOT bits are transparent to the VMN itself because the value is set to zero by the VMN and is cleared by the MVPN server 132 prior to the packet being forward to MVPN 122. The MR 134 adds HOS2 immediately following the ESP header, with the VMN CoA, and indicates this by setting the MOT bits in the modified SPI field in ESP header 1404 to 01.

If the next protocol field in the received packet is ESP, the MVPN server 132, starts its processing by looking at the value of the MOT field in the SPI. If it is set to 01, MVPN server 132 learns that that there are two levels of optimization, and the ESP header was added by the VMN 124. MVPN 132 obtains the VMN CoA from HOS2, sets the MOT bits to zero and strips away the HOS2 portion. The resultant packet is substantially identical to original optimized packet 1300 generated by VMN. This packet is forwarded to the VMN MVPN server 122. Note that the mapping between the VMN CoA and the VMN MVPN Server is already present at MVPN 132. The rest of the fields can be copied from the MR 134 reverse tunnel IP header. Moreover, the authentication in the ESP packet is not affected, since the packet is restored to the original packet sent out by the VMN 124. In the reverse direction, the MVPN 122 sends a packet from CN 110 to the VMN CoA with the MOT bits in the SPI set to 00. The packet, when it reaches the MVPN 132 (since the VMN CoA is on the mobile subnet of the MR 134), is further optimized by MVPN 132. MVPN 132 sets the MOT bits to 01 to indicate the double optimization and forwards the packet to MR 134.

In the foregoing specification, specific embodiments of the present invention have been described. However, one of ordinary skill in the art appreciates that various modifications and changes can be made without departing from the scope of the present invention as set forth in the claims below. For example, the teachings herein are applicable to nested mobile networks with one or more mobile networks behind a mobile network. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

What is claimed is:

1. A method for header optimization comprising the steps of:
receiving a first message comprising data and a first header having a first size, the first header including information to enable transporting of the first message from a source device to a destination device;
generating a first shim having a second size that is smaller than the first size, the shim comprising a first portion of the information in the first header;
generating at least a second header comprising a second portion of the information in the first header;
generating a second message comprising the data, the first shim and the at least a second header; and
forwarding the second message toward the destination device.

2. The method of claim 1, wherein the first portion of the information comprises at least one of a first Internet Protocol (IP) address for the destination device and a second IP address for the source device.

3. The method of claim 1, wherein the at least a second header comprises at least one of a security protocol header, a first Internet Protocol (IP) header associated with the security protocol header and a first mobility header.

4. The method of claim 3, wherein the at least a second header comprises the security protocol header and the first IP header and wherein the second portion of the information comprises at least one of next header information, identification and fragmentation fields, Type of Service field and Time to Live field from the first IP header.

5. The method of claim 4, wherein the security protocol header comprises an IPSec ESP header.

6. The method of claim 5 further comprising the step of encrypting the data and the first shim and performing an authentication protocol on the ESP header and encrypted data and first shim, wherein the authentication protocol is performed using at least some of the information in the first header to enable the recreation of the first header in a second node.

7. The method of claim 1 further comprising the step of indicating in the second message at least the presence of the first shim.

8. The method of claim 5 further comprising the step of using bits in a Security Parameter Index field of the ESP header for indicating presence of at least one of: the first shim and a type of the first shim; a More Fragments field in the first header; and IP options in the first header.

9. The method of claim 3, wherein the at least a second header comprises the security protocol header and the first mobility header and wherein the second portion of the information comprises at least one of next header information, identification and fragmentation fields, Type of Service field and Time to Live field from the first IP header.

10. The method of claim 9 further comprising the steps of:
generating the first IP header with at least some of the second portion of the information;
generating the first mobility header; and
copying the at least some of the second portion of the information from the first IP header to the first mobility header.

11. The method of claim 1 further comprising the steps of:
determining whether the first message includes a security protocol header;
if the first message includes a security protocol header, copying at least some of the second potion of the information into the security protocol header to generate the at least a second header; and
if the first message does not include a security protocol header, creating a security protocol header and copying at least some of the second potion of the information into the created security protocol header to generate the at least a second header.

12. The method of claim 1 further comprising the steps of:
detecting a level of traffic between the source and destination device that exceeds a threshold level;
generating an index that is representative of the source and destination device pair instead of generating the first shim, wherein the index has a third size that is smaller than the second size; and
embedding the index in the second message, wherein the second message comprises the data, the at least a second header and the index.

13. A method for header optimization comprising the steps of:
receiving a first message comprising data and at least a first header;
determining that the first message further comprises a first shim having a first size and including a first portion of information from a second header having a second size that is larger than the first size, the second header being included in a second message and the information from the second header to enable transporting of the second message from a source device to a destination device, wherein the at least a first header includes a second portion of the information from the second header;
recreating the second header using the first and second portions of information;
generating a third message using the data and the recreated second header; and
forwarding the third message toward the destination device.

14. The method of claim 13 further comprising the steps of:
obtaining state information associated with a first node connected to a mobile network behind a mobile node;
detecting that at least a third header was removed from the first message prior to the first message being sent; and
recreating, in one of the mobile node and a mobility agent, the third header using the state information, wherein the third message is generated further using the recreated third header.

15. The method of claim 14, wherein the at least a first header comprises a security protocol header and a mobility header for the mobile node and wherein the at least a third header comprises at least one of:
an Internet Protocol (IP) header associated with the security protocol header; and
a mobility header for the first node.

16. Apparatus for header optimization comprising:
a first interface receiving a first message comprising data and a first header having a first size, the first header including information to enable transporting of the first message from a source device to a destination device;
a processing device coupled to the first interface and:
generating a first shim having a second size that is smaller than the first size, the shim comprising a first portion of the information in the first header;
generating at least a second header comprising a second portion of the information in the first header; and
generating a second message comprising the data, the first shim and the at least a second header; and
a second interface coupled to the processing device and forwarding the second message toward the destination device.

17. The apparatus of claim 16, wherein:
the first interface further receiving a third message comprising second data and at least a third header;
the processing device further:
determining that the third message further comprises a second shim having a third size and including a first portion of information from a fourth header having a fourth size that is larger than the third size, the fourth header being included in a fourth message and the information from the fourth header to enable transporting of the fourth message from a second source device to a second destination device, wherein the at least a third header includes a second portion of the information from the fourth header;
recreating the fourth header using the first and second portions of information from the fourth header; and
generating a fifth message using the second data and the recreated fourth header; and
the second interface further forwarding the fifth message toward the destination device.

18. The apparatus of claim 16, wherein the first and second interfaces are one of wireless and wired.

19. The apparatus of claim 16, wherein the apparatus comprises at least one of: a mobile router, a mobile host, a home agent, a foreign agent and a virtual private network server.

20. The apparatus of claim 16, wherein the apparatus operates in accordance with at least one of: Internet Protocol version 4 (IPv4), IPv6, Mobile IP for IPv4, Mobile IP for IPv6 and IP Security Protocol.
